(19) United States
(12) Patent Application Publication
(10) Pub. No.: US 2026/0050771 A1
(43) Pub. Date: Feb. 19, 2026

(54) RESPONSE GENERATION BASED ON CHAIN-OF-THOUGHT REASONING

(71) Applicant: International Business Machines Corporation, Armonk, NY (US)

(72) Inventors: Hosam Aly, Ottawa (CA); Obidul Islam, Kanata (CA); Zhibo Zhang, Ottawa (CA); Rami Abou-Nassif, Ottawa (CA); Donald Banks, Ottawa (CA)

(21) Appl. No.: 18/807,231

(22) Filed: Aug. 16, 2024

(51) Int. Cl. G06N 3/0475; G06F 40/226

(52) U.S. Cl. CPC G06N 3/0475; G06F 40/226

(57) ABSTRACT

One or more systems, devices, computer program products and/or computer-implemented methods of use provided herein relate to response generation based on chain-of-thought reasoning. For example, a system can comprise a memory that can store computer executable components. The system can further comprise a processor that can execute the computer executable components stored in the memory, where the computer executable components can comprise a task determination component that can determine one or more tasks to be executed to generate a response to a question. The computer executable components can further comprise a task execution component that can execute a task of the one or more tasks based on an output of a previously executed task.

### BACKGROUND

The subject disclosure relates to natural language processing (NLP) and, more specifically, to response generation based on chain-of-thought reasoning.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable response generation based on chain-of-thought reasoning are discussed.

According to an embodiment, a system is provided. The system can comprise a memory that can store computer executable components. The system can further comprise a processor that can execute the computer executable components stored in the memory, where the computer executable components can comprise a task determination component that can determine one or more tasks to be executed to generate a response to a question. The computer executable components can further comprise a task execution component that can execute a task of the one or more tasks based on an output of a previously executed task.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example non-limiting system that can determine and execute one or more tasks to generate responses to natural language questions in accordance with one or more embodiments described herein.

FIG. 2 illustrates another block diagram of an example non-limiting system that can determine and execute one or more tasks to generate responses to natural language questions in accordance with one or more embodiments described herein.

FIG. 3 illustrates yet another block diagram of an example non-limiting system that can determine and execute one or more tasks to generate responses to natural language questions in accordance with one or more embodiments described herein.

FIG. 4 illustrates another block diagram of an example non-limiting system that can determine and execute one or more tasks to generate responses to natural language questions in accordance with one or more embodiments described herein.

FIG. 5 illustrates a flow diagram of an example non-limiting method that can employ a plurality of algorithms to process a question in accordance with one or more embodiments described herein.

FIG. 6 illustrates a flow diagram of an example non-limiting method that can employ chain-of-thought reasoning to generate a response to a question in accordance with one or more embodiments described herein.

FIG. 7 illustrates another flow diagram of an example non-limiting method that can employ a plurality of algorithms to process a question in accordance with one or more embodiments described herein.

FIG. 8 illustrates a flow diagram of an example non-limiting method that can determine and execute one or more tasks to generate responses to natural language questions in accordance with one or more embodiments described herein.

FIG. 9 illustrates another flow diagram of an example non-limiting method that can determine and execute one or more tasks to generate responses to natural language questions in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In a typical business intelligence (BI) software product, the sources of data employed by a software to respond to questions (e.g., queries, statements, etc., provided by an end entity) can vary and depend on the business operation and the size and type of the business operation. While most businesses rely on standard relational or OLAP data sources to respond to questions, the semantic representations and schema for such data sources are not uniform or standard. As a result, machine understanding of complex and compound business intelligence questions can be a challenging problem. For example, making a software understand and comprehend business related questions that can be provided to the software in a conversation formed in natural language can add complexity to the problem because business users desired answers as well as the reasons behind the answers.

Various embodiments of the present disclosure can be implemented to produce a solution to these problems in a scalable manner while providing reasoning when implementing artificial intelligence (AI). Embodiments described herein include systems, computer-implemented methods, and computer program products that can understand and answer complex questions (e.g., related to business intelligence, etc.) and provide reasoning in a conversation. For example, in various embodiments, a system comprising a set of software components can access questions (e.g., queries, sentences, etc.) in natural language as part of a conversation. For example, the system can comprise an agent that can analyze a question as either a single/individual question or as part of a conversation and generate a response. The agent can employ a large language model (LLM) to divide complex questions into several tasks (or steps), wherein each task can be associated with reasoning. To divide a question, the agent can rely on the knowledge base in the LLM. For example, to generate a response to a question related to business concepts, the agent can rely on a knowledge base of the LLM related to complex business analytics concepts.

In various embodiments, the agent can be fed with or have access to a set of algorithms (also known as tools). Each algorithm can be associated with a name and natural language description indicating the type of tasks that the algorithm is capable of executing. For example, the set of algorithms can comprise an entity extraction algorithm, an intent detection algorithm, a data retrieval algorithm, and so on. The agent can employ the natural language descriptions of the algorithms in conjunction with the knowledge base of the LLM to select the best algorithms that can be executed to respond to a question (e.g., analytic question or other type of question). An algorithm thus selected can be executed as a step in the process of generating the response. Executing an algorithm can imply calling or engaging the algorithm given a question, contextual information related to the question and the output of a previously executed task (if any). Thus, respective tasks applicable to respond to the question can be executed by respective algorithms selected from the set of algorithms. After the execution of an algorithm, the agent can validate (e.g., verify) the output generated. Based on the validation, the agent can determine whether the output is indicative of the answer or insight sought for the question. If the output represents an invalid or incomplete answer or insight, the agent can employ the LLM to select and execute a different algorithm, thereby executing another task. Stated differently, the agent can validate the output of each task and determine whether the response generation process can be concluded or stopped.

In various embodiments, the agent can also generate a reasoning that can explain a task executed in connection with a question. In various embodiments, each algorithm employed by the agent can be a simple operation, an AI algorithm, or an algorithm identical to the agent that can further divide a task into subtasks. In this regard, each algorithm can be another system that can execute subtasks to generate the output of a task. It was observed that smaller tasks can be more desirable than larger tasks. For example, each algorithm can generate the best output when a task is not overly technical and can be easily understood by the LLM (as well as a human). Thus, the agent can interact with an LLM to understand the concepts associated with a question (e.g., business intelligence concepts, analytics concepts, and other industry specific concepts) for task breakdown, reasoning for the analytics, and execution of algorithms. Further, the agent can generate an explanation/reasoning for each step in a complex chain-of-thought reasoning employed by the agent to respond to the question, wherein the reasoning for each step can be output to an end entity (e.g., hardware, software, machine, AI, neural network and/or user) in addition to the response to the question.

Although some existing techniques can generate reasoning for a task or employ LLMs to execute tasks, such techniques do not account for business intelligence specific applications, business intelligence specific applications with LLMs, business intelligence related agents or conversational domains. An existing technique employs a single algorithm (or tool) that encapsulates a hard-coded path of steps to generate responses to questions. The existing technique can solve financial problems by employing an LLM to draw inference from a large corpus of financial text information. Additionally, the existing technique is directed to explainability rather than reasoning. On the contrary, the various embodiments of the present disclosure can employ an LLM and a sequence of algorithms to solve complex business intelligence or analytics based questions, wherein the output of an algorithm can direct the sequence and influence the selection of algorithms in the sequence. Further, the various embodiments of the present disclosure can be applied to any business intelligence or analytics based problem by employing only structured data instead of a knowledge base. Business intelligence based questions and problems can originate from a wide variety of domains such as financial centres, educational institutes, hospitals, or any other business that generates data. Thus, the embodiments of the present disclosure are not restricted to any particular domain.

The algorithms leveraged in the various embodiments of the present disclosure can be solve more extensive problems than the narrow problem of generating a single financial calculation. For example, in some implementations, the various embodiments of the present disclosure can employ algorithms that can order more inventory, send a message to a specific user if a threshold is met, explain the potential causes for a drop in income, and so on. By employing a chain-of-thought reasoning, the various embodiments of the present disclosure can chain inputs/outputs of algorithms in a manner that can emulate human reasoning, and the natural output generated by the chain-of-thought reasoning can provide an explanation for how the algorithms (and the corresponding tasks executed to respond to a question) are chosen.

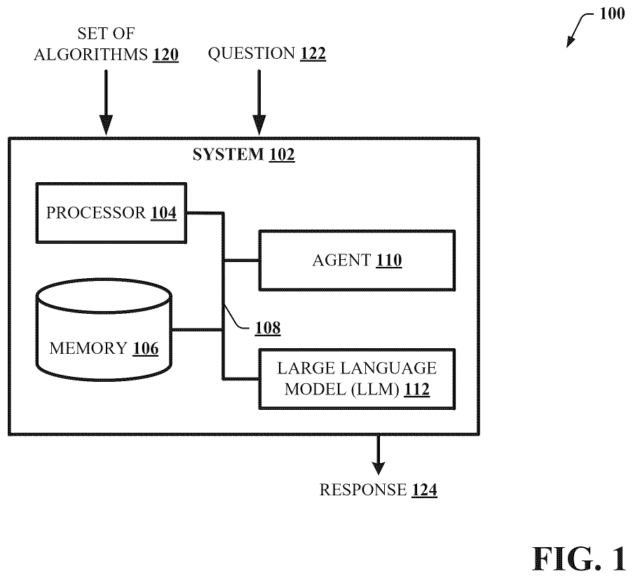

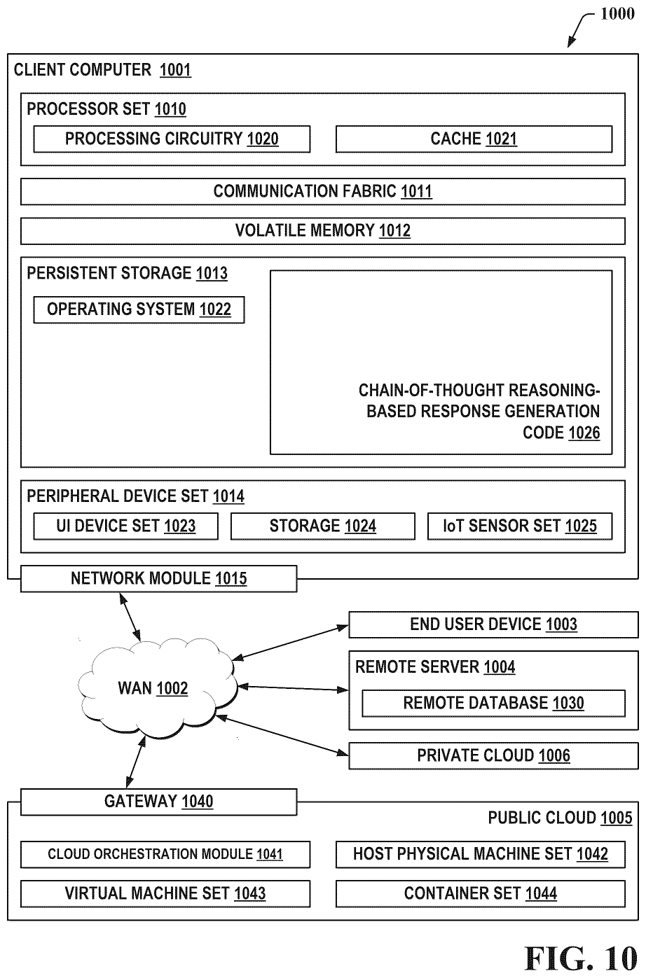

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, non-limiting system 100 can be associated with, such as accessible via, a computing environment 1000 described below with reference to FIG. 10, such that aspects of processing can be distributed between non-limiting system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example non-limiting system 100 that can determine and execute one or more tasks to generate responses to natural language questions in accordance with one or more embodiments described herein.

Non-limiting system 100 and/or the components of non-limiting system 100 can be employed to use hardware and/or software to solve problems that are highly technical in nature (e.g., related to NLP, machine learning models, response generation based on AI, etc.), that are not abstract and that cannot be performed as a set of mental acts by a human. Further, some of the processes performed may be performed by specialized computers for carrying out defined tasks related to the response generation based on chain-of-thought reasoning. Non-limiting system 100 and/or components of the system can be employed to solve new problems that arise through advancements in technologies mentioned above and/or the like. Non-limiting system 100 can provide improvements to NLP systems by improving the accuracies of responses generated by a machine learning model, wherein the machine learning model can employ chain-of-thought reasoning to generate responses to questions and further employ a vector database to improve the accuracy and relevance of previously processed questions employed for the chain-of-thought reasoning, which can continuously improve the accuracies of the responses.

Non-limiting system 100 can comprise system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., agent 110, LLM 112, access component 202, task determination component 204, task execution component 206, validation component 302, rephrasing component 304, display component 306 and/or feedback component 402) to perform one or more actions. In one or more embodiments, memory 106 can store computer-executable components (e.g., agent 110, LLM 112, access component 202, task determination component 204, task execution component 206, validation component 302, rephrasing component 304, display component 306 and/or feedback component 402).

System 102 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 102 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 102 can reside in the cloud, and/or can reside locally in a local computing environment (e.g., at a specified location(s)).

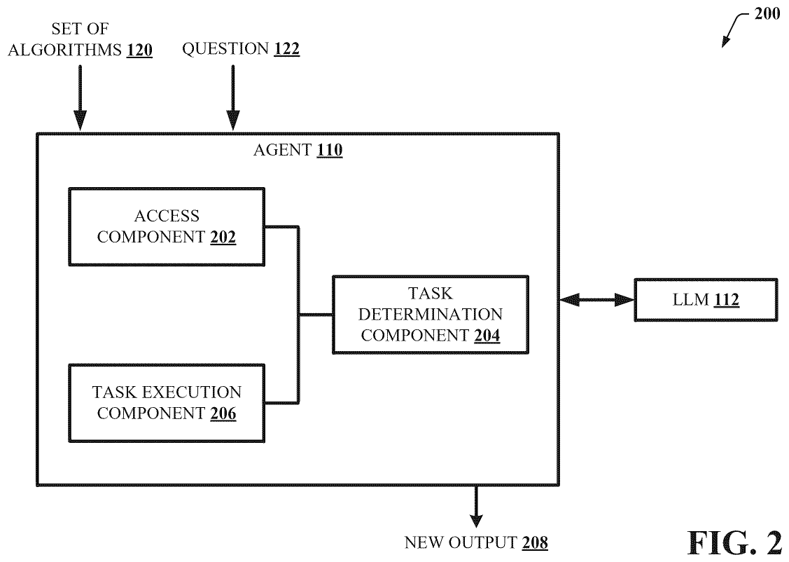

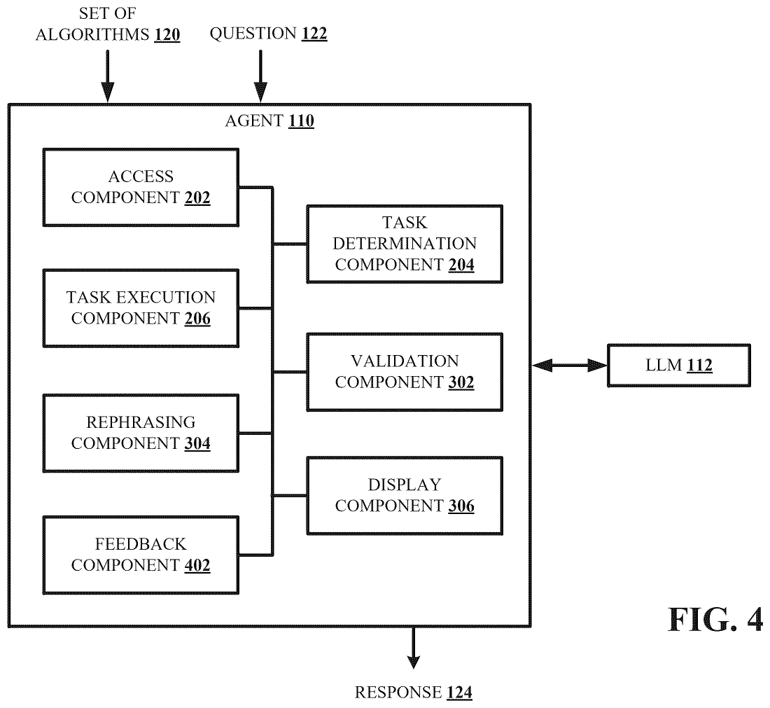

In one or more embodiments, system 102 can comprise agent 110. As illustrated in FIGS. 2-4, agent 110 can comprise access component 202, task determination component 204, task execution component 206, validation component 302, rephrasing component 304, display component 306 and feedback component 402.

In one or more embodiments, agent 110 can be a system, such as a software that can be implemented in a software-based application (e.g., an application directed to conversational systems, natural language generation and/or machine translation) that can process questions generated in natural language and generate responses to such questions based on a chain-of-thought reasoning. Agent 110 can interact with LLM 112 and employ the components comprised in agent 110 to generate the responses. For example, in one or more embodiments, access component 202 can access question 122, wherein question 122 can be generated in natural language during a verbal or textual conversation. For example, question 122 can be a text or voice input generated by an entity (e.g., hardware, software, machine, AI, neural network and/or user) and accessed by access component 202 via a device (e.g., desktop computer, laptop computer, tablet, smartphone, etc.) through a user interface (UI), microphone, etc. associated with the device.

In one or more embodiments, agent 110 can utilize a vector database to store and retrieve embeddings of questions previously addressed by agent 110 and the solutions corresponding to such questions, to enhance the accuracy and relevance of the chain-of-thought reasoning employed by agent 110 in processing natural language inputs. Upon accessing a new question (or query), agent 110 can search the vector database for semantically similar questions. The questions retrieved by agent 110, particularly questions with successful outcomes, can be injected into a prompt as examples to guide LLM 112 in generating an optimal chain of thought.

More specifically, in one or more embodiments, task determination component 204 can determine one or more tasks to be executed to generate a response to question 122. For example, task determination component 204 can search a vector database comprising embeddings of questions and embeddings of responses to the questions. The vector database can be stored in a memory, such as memory 106 or another memory, that can be accessible to agent 110. Task determination component 204 can retrieve from the vector database, by employing AI, a set of questions that can be semantically similar to question 122. Based on the set of questions, task determination component 204 can generate a prompt comprising question 122, contextual information associated with question 122, and the set of questions retrieved from the vector database. Thereafter, task determination component 204 can process the prompt via LLM 112 and determine the one or more tasks that can be executed to generate response 124, wherein response 124 can represent a response, solution or insight to question 122.

To retrieve questions that are semantically similar to question 122, task determination component 204 can perform fuzzy matching by converting both question 122, and the questions stored in the vector database, into high-dimensional vectors, typically by employing embeddings generated by a pre-trained language model (i.e., a pre-trained machine learning model). The embeddings thus generated can capture the semantic meaning of the text in question 122 and the questions stored in the vector database, thereby allowing task determination component 204 to measure the similarity between questions beyond exact keyword matches. Thus, when question 122 is provided or submitted via an entity (e.g., hardware, software, machine, AI, neural network and/or user) to agent 110 and accessed by access component 202, task determination component 204 can compute a vector representation of question 122 and perform a nearest-neighbor search within the vector database to find vectors that are most similar to the vector representation of question 122. Vectors that are most similar to the vector representation of question 122 can correspond to questions previously addressed by agent 110 and stored in the vector database. In some implementations, task determination component 204 can optimize the search by employing approximate nearest-neighbor (ANN) algorithms that can efficiently identify vectors that are close to each other in a high-dimensional space. The closest matching questions, determined by the proximity of their vectors to the vector representation of question 122, can then be selected by task determination component 204 to generate the prompt, and the prompt can be employed to parse question 122.

In various embodiments, the prompt can additionally comprise a set of algorithms 120. In various embodiments, one or more of the algorithms comprised in the set of algorithms 120 can be AI algorithms. The set of algorithms 120 can comprise algorithms that can be executed to generated response 124, and the set of algorithms 120 can comprise algorithms previously employed by LLM 112, for example, to generate the responses to the questions retrieved from the vector database. Additionally, respective algorithms comprised in the set of algorithms 120 can be associated with respective names and respective natural language descriptions, wherein the natural language description of an algorithm can describe the type of task that the algorithm can execute. In various embodiments, task determination component 204 can input the prompt into LLM 112. LLM 112 can process the prompt and determine the one or more tasks executable to generate response 124. For example, the questions retrieved from the vector database can indicate the type of questions that LLM 112 can expect to encounter in the future. For example, based on the questions retrieved from the vector database, LLM 112 can determine the type or category of question 122. Further, the questions retrieved from the vector database can be questions previously processed by LLM 112, and LLM 112 can access (e.g., from a memory accessible to LLM 112) historical knowledge about the tasks and the corresponding algorithms previously executed by LLM 112 to generate the responses to the questions retrieved from the vector database. Based on the historical knowledge and the semantic similarity of the questions retrieved from the vector database to question 122, LLM 112 can identify the one or more tasks that can be executed to generate response 124 for question 122. Further, LLM 112 can identify a sequence in which the one or more tasks can be executed. It should be appreciated that question 122 can be a query or a sentence, such as a request for statistical or other type of information.

In one or more embodiments, LLM 112 can be further employed by task execution component 206 to execute the one or more tasks. For example, respective tasks of the one or more tasks determined by task determination component 204 can be executable via respective algorithms comprised in the set of algorithms 120. LLM 112 can further identify, based on the prompt input to LLM 112, the respective algorithms that can be employed to execute respective tasks the one or more tasks. For example, by comparing the historical knowledge of tasks previously executed by LLM 112 with the respective natural language descriptions of the respective algorithms comprised in the set of algorithms 120, LLM 112 can determine the algorithms that can be employed to execute tasks. Thus, task execution component 206 can employ LLM 112 to identify and execute the algorithms corresponding to the one or more tasks. Since the set of algorithms 120 can comprise a large number of algorithms, the number of combinations of algorithms that can be employed to execute the one or more tasks can also increase, and providing the most relevant questions and responses as examples to LLM 112 can assist LLM 112 to successfully generalize the selection of algorithms to execute the one or more tasks. Thus, in various embodiments, agent 110 can intelligently select the questions that can be included into the prompt input into LLM 112 and eliminate irrelevant examples. In this regard, agent 110 can be a machine learning model that can be trained to intelligently select semantically similar questions from the vector database.

Further, task execution component 206 can orchestrate the execution of the one or more algorithms, via LLM 112, according to the sequence determined by LLM 112 for the one more tasks. Accordingly, task execution component 206 can identify and select/engage, via LLM 112, the algorithm that can execute the first task. For example, to engage an algorithm to execute a task, LLM 112 can input information from question 122 into the algorithm, and only the information from question 122 that can be applicable to the first task can be input into the algorithm. For example, the first task can be an entity extraction task, and LLM 112 can select an entity extractor (i.e., entity extraction/extractor algorithm) to execute the first task. LLM 112 can input into the entity extractor, only the portion of question 122 that can be relevant to the entity extraction task. The algorithm can execute the first task and generate an output.

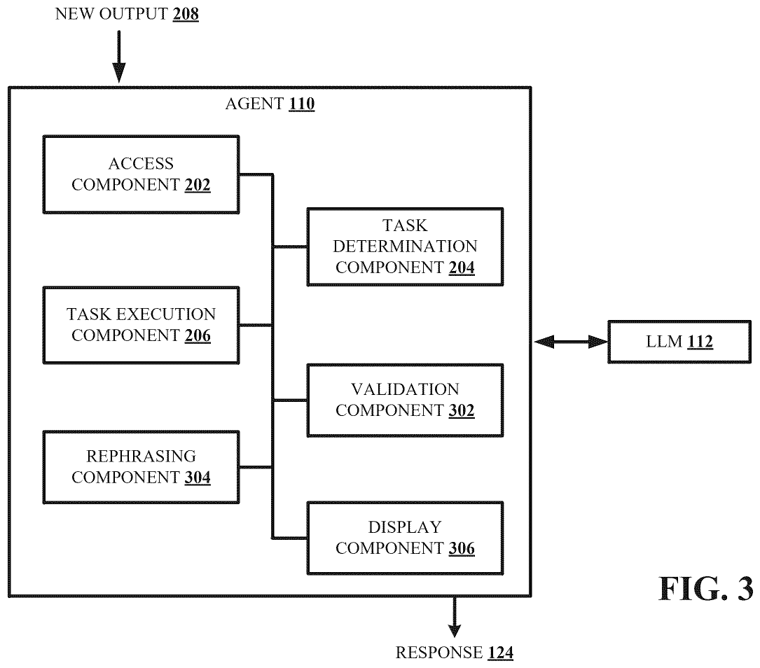

In one or more embodiments, task execution component 206 can execute a subsequent task of the one or more tasks, based on the output of the previously executed task. For example, upon generation of the output corresponding to the first task, task execution component 206 can select another algorithm from the set of algorithms 120 by analyzing, via LLM 112, the output of the previously executed task and a natural language description of the algorithm. For example, task execution component 206 can input a prompt into LLM 112, wherein the prompt can comprise information from question 122 applicable to the subsequent task, contextual information associated with question 122, and the output of the previously executed task. The prompt can additionally comprise the set of algorithms 120. Based on the prompt, LLM 112 can analyze the output of the previously executed task, and given the respective natural language descriptions of the respective algorithms comprised in the set of algorithms 120, LLM 112 can select an algorithm to execute the subsequent task. Task execution component 206 can execute, via LLM 112, the algorithm to process information comprised in the output, wherein the algorithm can further execute a set of subtasks related to the task. As a result, task execution component 206 can generate, via LLM 112, new output 208 (FIGS. 2 and 3) and a reasoning based on execution of the algorithm.

For example, in one or more embodiments, validation component 302 can parse the new output and validate the new output with respect to question 122. Validation component 302 can parse the output without employing LLM 112, whereas validation component 302 can employ LLM 112 to validate the parsed output. Validating an output can comprise determining, via LLM 112, whether response 124 has been generated. For example, based on the prompt input into LLM 112 by task execution component 206, LLM 112 can check whether an output represents a complete response to question 122. In an embodiment, task execution component 206 can identify a new task to be executed, upon a determination that new output 208 represents an invalid, incomplete or failed response to question 122. Further, task execution component 206 can select and execute, via LLM 112, a different algorithm from the set of algorithms to execute the new task. In another embodiment, task execution component 206 can execute the subsequent task with more context or a different algorithm, upon a determination that new output 208 represents an invalid, incomplete or failed response to question 122. In yet another embodiment, rephrasing component 304 can generate response 124 by transforming (e.g., translating) new output 208 to a format applicable to question 122, upon a determination that new output 208 represents a complete and valid response to question 122. For example, the question “Why did the revenue drop?” can be answered in natural language, but a response to the query “Show me the drop in revenue” can be generated as a chart. In one or more embodiments, display component 306 can display, at a UI of a device (e.g., a device employed to access agent 110), response 124 and a reasoning associated with each task of the one or more tasks executed to generate response 124.

In one or more embodiments, task execution component 206 can generate, via LLM 112, a reasoning for each output, wherein the reasoning for an output can comprise detailed information, for example, about why the output comprises a certain conclusion. In one or more embodiments, validation component 302 can parse and validate each output generated for question 122, and validation component 302 can employ LLM 112 to validate outputs. In various embodiments, display component 306 can display, at a UI of a device (e.g., a device employed to access agent 110), respective outputs generated by executing respective tasks of the one or more tasks and the reasoning associated with each task and output, during generation of response 124. For example, an entity (e.g., hardware, software, machine, AI, neural network and/or user) can view the reasoning for each output generated towards generation of response 124 during execution of the one or more tasks and the corresponding algorithms. In this regard, various embodiments of the present disclosure can employ chain-of-thought reasoning to generate a response to a question (or query), wherein the question can be divided into smaller tasks and the reasoning of the output of one task can guide the execution of the next task and the selection of an algorithm to execute the next task.

As previously stated, task execution component 206 can orchestrate the execution of the various algorithms selected from the set of algorithms 120. In this regard, task execution component 206 can control the algorithms and manage the history of execution of the one or more tasks. For example, task execution component 206 can ensure that at every step of execution of the one or more tasks, the LLM 112 is aware of the sequence of tasks that have occurred prior to that step so that LLM 112 can avoid repeating a task that has already been executed. For example, task execution component 206 can record the execution of the first task, store the details of the execution in a memory, such as memory 106, and input the details of the execution into LLM 112 via the prompt to ensure that LLM 112 is aware that only the first task has been executed. In this regard, in various embodiments, LLM 112 can be an intermediate tool between question 122 and the set of algorithms 120, wherein LLM 112 can be any suitable LLM that is not built or trained on customer data such as, for example, data that is specific to a business or organization employing agent 110. Thus, agent 110 can be model independent since agent 110 does not rely on propriety LLMs or any specific LLM. Additionally, in one or more embodiments, since LLM 112 can employ algorithms from the set of algorithms 120 to execute the one or more tasks and generate response 124, the customer data can remain hidden from LLM 112.

In various embodiments, rephrasing component 304 can transform the output of the first task or any subtasks executed as part of the first task, into natural language, prior to the prompt being input into LLM 112 by task execution component 206, because LLMs process data in natural language. For example, each algorithm of the set of algorithms 120 can employ a unique format (e.g., comma-separated values (CSV), JavaScript Object Notation (JSON), Extensible Markup Language (XML), natural language, etc.) to process data and generate an output based on the data. As a result, the output of an algorithm can have a format other than natural language. For example, the output of the first task can be instructions for rendering a chart or another formatted output as requested by question 122. In various embodiments, rephrasing component 304 can transform the output of an algorithm into a natural language format that LLM 112 can comprehend, which can assist task execution component 206 to ensure that LLM 112 is aware of the history of execution of the one or more tasks. For example, the query “Send a message to Bob via a messaging app” can be provided to an algorithm as a task to be executed by the algorithm. Accordingly, the algorithm can determine the contacts details for Bob and send the message to Bob, and the algorithm can send a command to LLM 112 indicating that the message was indeed sent. If the algorithm cannot determine the contact details for Bob, the algorithm can send a query back to LLM 112 to request additional details that can assist the algorithm to send the message to Bob. The communication from the algorithm to LLM 112 can be in the form of a code that cannot be deciphered by LLM 112, and rephrasing component 304 can transform the code into a natural language format that can be deciphered by LLM 112. Doing so can also assist LLM 112 to select the algorithm to execute the subsequent task, and further assist validation component 302 to validate respective outputs generated for the one or more tasks.

In various embodiments, upon selecting the algorithm that can execute the subsequent task based on the first task, LLM 112 can transform the output from the natural language format into the format native to the algorithm. For example, while the entity extractor can accept inputs in natural language, other algorithms can employ different formats such CSV, JSON, XML, etc. that can be raw formats (i.e., formats that are not easily understandable by humans). LLM 112 can transform the natural language format of the output into a format (e.g., CSV, JSON, XML or another format) that can be applicable to and understood by the algorithm that can execute the subsequent task.

In one or more embodiments, an algorithm of the set of algorithms 120 employed to execute a task can further execute a set of subtasks to execute the task. In this regard, one or more algorithms comprised in the set of algorithms 120 can be identical to agent 110. For example, each task executed to generate response 124 can be processed as an individual query by an algorithm, wherein the algorithm can employ one or more components (e.g., access component 202, task determination component 204, task execution component 206, validation component 302, rephrasing component 304, display component 306 and/or feedback component 402) to subdivide the task into a set of subtasks, employ LLM 112 or another LLM to select and execute an algorithm to execute a subtask, and display the results of the task at a UI of a device (e.g., desktop computer, laptop, tablet, smartphone, etc.), to an entity (e.g., hardware, software, machine, AI, neural network and/or user). That is, each algorithm employed to execute a task can further execute a chain of algorithms to address the set of subtasks. For example, the entity extraction task can be executed by multiple algorithms that can be accessed by an entity extractor. In this regard, in some embodiments, system 102 can be a recursive system.

In one or more embodiments, feedback component 402 can provide a feedback mechanism employable to generate feedback on response 124. For example, feedback component 402 can provide an interactive feedback mechanism, wherein entities (e.g., hardware, software, machine, AI, neural network and/or users) can select a “thumbs-up” or “thumbs-down” option for response 124. The “thumbs-up” option can indicate a positive or favorable feedback, and the “thumbs-down” option can indicate a negative or unfavorable feedback. Entities can select such options at a UI of a device via the click of a mouse button, a touchscreen mechanism, voice, or another suitable mechanism. Recall that agent 110 can utilize a vector database to store and retrieve embeddings of questions previously addressed by agent 110 and their corresponding solutions, to enhance the accuracy and relevance of the chain-of-thought reasoning employed by agent 110 in processing natural language inputs. A positive feedback on response 124 can trigger an update to the vector database, reinforcing the association between question 122 and a successful resolution to question 122. For example, access component 202 can access the positive feedback and task determination component 204 can update the vector database. Conversely, negative feedback can trigger agent 110 to de-prioritize question 122 and response 124 as less effective examples, which in some embodiments, can lead to the generation of new embeddings that can more accurately capture the intent of a question. Such a continuous learning loop can ensure that the agent 110 and system 102 evolve over time, thereby delivering increasingly accurate and contextually relevant responses. In this regard, agent 110 can be a machine learning model that can employ chain-of-thought reasoning to generate responses to questions, which can continuously improve the accuracies of the responses.

In summary, non-limiting system 100 can employ an agent to create a list of tasks executable to generate a response to a question by employing an LLM. The agent can execute the first task from the list of tasks, parse and validate the output of the first task against the question, and stop execution of the list of tasks if the response for the question has been generated. The agent can also attempt to execute the first task again or execute a new task with more context if the output of the first task indicates an invalid, incomplete or failed response, and proceed to the next task, providing the output of the first task to the next task. The respective algorithms employed to execute the respective tasks can be arbitrarily implemented in a desired manner. In various embodiments, an algorithm itself can be an agent, wherein the algorithm can divide a task into subtasks, thereby simplifying the task to be understood by LLMs.

FIGS. 2-4 illustrate a block diagram of an example non-limiting system 200 that can determine and execute one or more tasks to generate responses to natural language questions in accordance with one or more embodiments described herein. Repetitive description of like elements and/or processes employed in respective embodiments is omitted for sake of brevity.

Non-limiting system 200 illustrates the system of agent 110 and LLM 112. As described with reference to FIG. 1, in one or more embodiments, agent 110 can comprise access component 202, task determination component 204, task execution component 206, validation component 302, rephrasing component 304, display component 306 and/or feedback component 402. In various embodiments, the one or more components of agent 110 can be employed by agent 110 in a chain-of-thought reasoning process to generate responses to questions. The chain-of-thought reasoning process has been detailed with reference to FIG. 1 and further summarized by the following example.

According to an example, question 122 can comprise the query “Find the city with the biggest drop in revenue last quarter, speculate on some reasons why the drop, compose a report and send that by a messaging application to Barb.” In various embodiments, task determination component 204 can employ LLM 112 to subdivide the query into multiple tasks, and task execution component 206 can employ LLM 112 to select and execute algorithms to execute the tasks. For example, task determination component 204 can determine, via LLM 112, that the first task to be executed can be the identification of the city with the biggest drop in revenue. Thereafter, task execution component 206 can select and execute, via LLM 112, an algorithm to execute the first task. For example, task execution component 206 can select, via LLM 112, an entity extractor to identify the words “city” and “revenue,” and to further identify corresponding database columns. The first task can concern only a portion (i.e., “Find the city with the biggest drop in revenue”) of question 122, and thus, LLM 112 can provide only the relevant portion of question 122 to the entity extractor to execute the first task. Rephrasing component can transform the output of the first task into natural language, based on which LLM 112 can comprehend that the entity extractor has identified two columns corresponding to the words “city” and “revenue.”

LLM 112 can also recognize that question 122 has not been completely resolved. For example, validation component 302 can parse the output, and validation component 302 can validate the output, via LLM 112, against question 122. Based on the validation, LLM 112 can determine that question 122 has not been completely answered. For example, the output of the first task can be “The city with the biggest drop in revenue is New York City,” which only answers a portion of question 122. Accordingly, task execution component 206 can select and execute, via LLM 112, one or more algorithms to execute additional tasks, wherein LLM 112 can transform the output of the first task from the natural language format into a format that can be processed by the downstream chain of algorithms employed to execute the additional tasks. For example, LLM 112 can employ another algorithm to execute a second task, wherein the algorithm can select past advertising data and find advertising decline during prior months. The output of the second task (e.g., new output 208) can be “New York City revenue dropped by 23% last quarter. New York City undersold in t-shirts last quarter.”

The output of the second task can be further parsed and validated by validation component 302 after which, a third task can be executed. The output of the third task can comprise the messaging application (tool) looking up the contact details for Barb and redirecting the output of the second task to Barb. Based on the output of the third task, validation component 302 can validate, via LLM 112, that question 122 has been completely answered. For example, the algorithm employed to execute the third task can communicate to LLM 112 that the output of the second task has been sent to Barb. The communication from the algorithm to LLM 112 can be in the form of code, and rephrasing component 304 can transform the code into natural language that LLM 112 can comprehend. Thereafter, validation component 302 can validate that the output of the third task indicates that question 122 has been completely answered. Thus, in various embodiments, each algorithm can generate a premature output, and agent 110 can determine whether the output represents a complete response (e.g., response 124) to question 122. If so, the output can be presented to an end entity, for example, an entity that generated question 122.

For example, in one or more embodiments, display component 306 can display response 124 for question 122 at the UI of a device. An entity (e.g., hardware, software, machine, AI, neural network and/or user) can provide feedback, via the UI, on the response 124 via an interactive feedback mechanism provided by feedback component 402. Additionally, in one or more embodiments, display component 306 can display the outputs of all three tasks executed by task execution component 206 and the reasoning for each task at the UI of a device. For example, the reasoning corresponding to the second task can indicate that product sizing and advertising were identified as the key drivers for revenue, and display component 306 can display the output of the second task and the corresponding reasoning at the UI. It should be noted that the feedback mechanism is not intended for the entity to reshape or redirect the process of generating response 124. In one or more embodiments, the reasoning generated for a task can assist LLM 112 to determine whether question 122 has been completely resolved and also to determine the confidence in whether the final solution to question 122 is correct.

Thus, the various embodiments herein can provide a system that can execute a chain-of-thought reasoning process, wherein the system can constantly evaluate whether a question has been resolved. If not, the system can determine the subsequent tasks to be executed to resolve the question. Additionally, the system can comprise intelligence that can recognize whether the solution for a task has been attained. Accordingly, the system can redirect the output of the task to a subsequent task in the process, instead of repeating the task. For example, if the output of a task represents an invalid or partially complete response to the question, the system can execute additional tasks to generate a complete response. In various embodiments, the system can maintain the questions that have been successfully resolved in a memory.

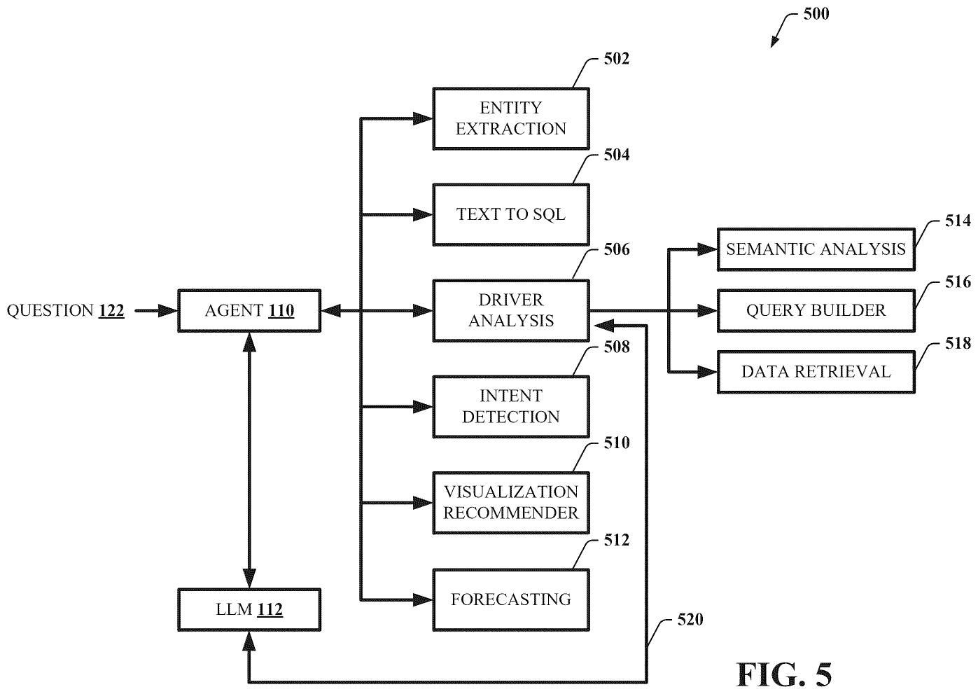

FIG. 5 illustrates a flow diagram of an example non-limiting method 500 that can employ a plurality of algorithms to process a question in accordance with one or more embodiments described herein. Repetitive description of like elements and/or processes employed in respective embodiments is omitted for sake of brevity.

Non-limiting method 500 illustrates the algorithms that can be employed in an exemplary application of the various embodiments disclosed herein. As described with reference to FIG. 1, agent 110 can access question 122. Agent 110 can employ LLM 112 and a chain-of-thought reasoning to determine/create one or more tasks that can be executed to generate a response to question 122, wherein each task can be associated with a reasoning. Agent 110 can further select and execute suitable algorithms to execute the one or more tasks. Agent 110 can engage an algorithm to execute a task of the one or more tasks, and upon execution of the task, agent 110 can parse and validate/verify (via LLM 112) the output of the task. If the output represents an invalid or incomplete response to question 122, agent 110 can determine, via LLM 112, a subsequent task to be executed, based on the output of a previously executed task. The process of determining a task to be executed, selecting and executing an algorithm to execute the task, parsing the output of the task and validating the output can continue until agent 110 can validate that an output represents a response (e.g., response 124) to question 122. Thereafter, the process can be terminated, and agent 110 can store the memory of the conversation (e.g., in memory 106).

In one or more embodiments, agent 110 can select and execute, via LLM 112, a variety of different algorithms, based on the one or more tasks to be executed. The algorithms can be selected from set of algorithms 120. For example, at 502, agent 110 can select an entity extraction algorithm to execute a first task. An entity extraction algorithm can access data in natural language and identify database columns for relevant categories. At 504, agent 110 can select a text to Structured Query Language (SQL) algorithm. The text to SQL (text 2 SQL) algorithm can be a variation of the entity extraction algorithm and can generate SQL directly, instead of just generating columns. Thus, the text to SQL algorithm can represent a different technique of generating SQL. Additionally, the text to SQL algorithm can be more applicable to complex queries having, for example, nested SELECT statements inside of SELECT statements.

At 506, agent 110 can select the driver analysis algorithm. Driver analysis can correspond to a problem that agent 110 can be aware of, wherein the problem can be broken down into smaller steps. The driver analysis algorithm can be a catch-all for a variety of techniques to understand the influence between columns. For example, to understand why revenue has dropped for a business, driver analysis can identify other database columns for categories that have impacted revenue historically. For example, driver analysis can break down information into various columns to identify columns of categories that may have impacted the revenue for the business within a designated time period. As stated elsewhere herein, an algorithm selected by agent 110 to execute a task can further identify, via LLM 112 or another LLM, subtasks to be executed and employ a set of algorithms to execute the subtasks. In FIG. 5, this concept is illustrated in the context of the driver analysis algorithm. For example, the driver analysis algorithm can act as a chained agent, and the corresponding driver analysis task can be broken into multiple subtasks.

Accordingly, the driver analysis algorithm can employ a semantic analysis algorithm, a query builder algorithm, and a data retrieval algorithm to build reasoning, for example, around why the revenue for the business dropped. For example, at 514, the driver analysis algorithm can employ the semantic analysis algorithm that can determine whether the revenue increased, dropped, or demonstrated another behavior. The semantic analysis can solve a natural language problem to comprehend a bigger problem or task to be executed. At 516, the driver analysis algorithm can employ the query builder algorithm that can acquire data and examine the data. At 518, the driver analysis algorithm can employ the data retrieval algorithm that can retrieve data. The driver analysis algorithm can employ the additional algorithms (i.e., semantic analysis, query builder and data retrieval algorithms) to generate multiple columns of categories and determine one or more causes for the drop in the revenue. For example, the driver analysis algorithm can determine a first cause responsible for a 6% drop in the revenue, a second cause responsible for a 40% drop in the revenue, and so on. As illustrated at 520, the driver analysis algorithm can employ LLM 112 or another LLM to select and execute additional algorithms.

In some implementations, agent 110 can additionally select, at 508, an intent detection algorithm. The intent detection algorithm can determine the intent of question 122 at a high level, although intent detection can be less applicable to determining why the revenue for a business has dropped. At 510, agent 110 can select a visualization recommender algorithm that can recommend certain charts (e.g., scatter charts, bar charts, etc.) given the database columns. At 512, agent 110 can select a forecasting algorithm that can perform predictive analysis, for example, to predict future data, given current data such as the database columns and the influences within the database columns. FIG. 5 illustrates non-limiting examples of algorithms for a specific application of agent 110, and the embodiments of the present disclosure are not limited to the application of any specific algorithms. Thus, different applications of the various embodiments herein can involve other algorithms not mentioned herein to execute different tasks. Each algorithm selected by agent 110, the driver analysis algorithm and/or another algorithm can be influenced by the output resulting from execution of a previous algorithm in the sequence.

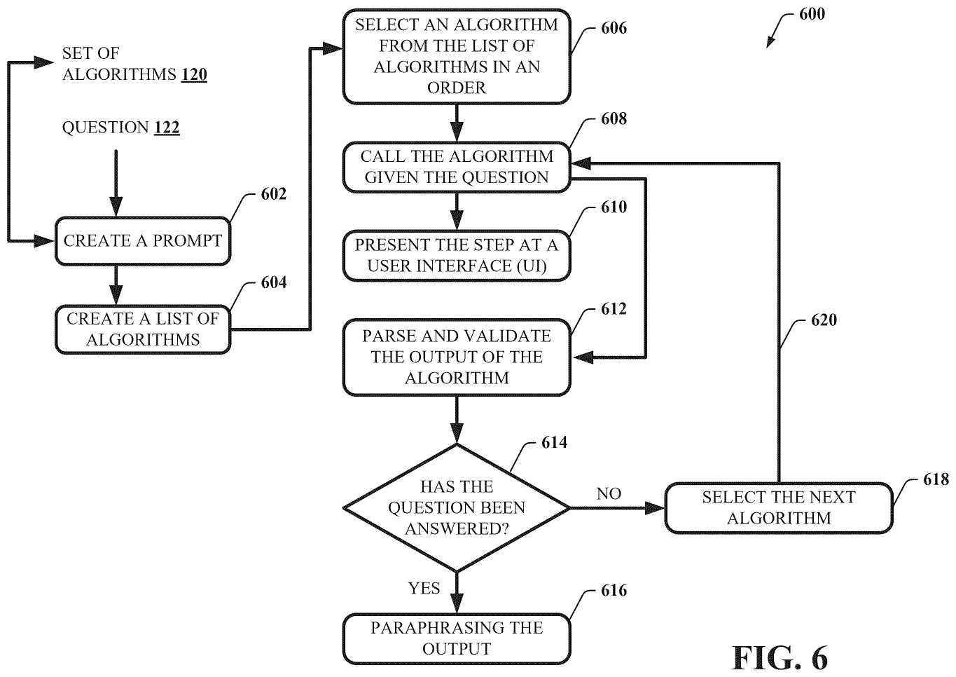

FIG. 6 illustrates a flow diagram of an example non-limiting method that can employ chain-of-thought reasoning to generate a response to a question in accordance with one or more embodiments described herein. Repetitive description of like elements and/or processes employed in respective embodiments is omitted for sake of brevity.

Non-limiting method 600 illustrates the chain-of-thought reasoning process described in the various embodiments disclosed herein. As described with reference to FIG. 1, in various embodiments, a system (e.g., non-limiting system 100) can be provided. The system can comprise agents and algorithms, wherein the agents can be executable in a loop. For example, a prompt comprising the set of algorithms 120, question 122, and contextual information associated with question 122 can be provided to agent 110 or LLM 112. Each algorithm in the set of algorithms 120 can be associated with a natural language description (e.g., algorithm 1—description, algorithm 2—description, etc.). The respective natural language descriptions of the respective algorithms can assist LLM 112 to determine a task that an algorithm can execute. A set of exemplary questions that can be semantically similar to question 122 can be additionally provided to LLM 112 via the prompt, based on which LLM 112 can determine one or more tasks and the corresponding algorithms executable to solve complex analytical problems. For example, agent 110 can employ a chain-of-thought reasoning technique (prompt technique) in conjunction with LLM 112 to divide question 122 into a series of tasks/steps that can be executable via algorithms comprised in the set of algorithms 120.

Specifically, at 602, non-limiting method 600 can comprise employing LLM 112 (e.g., by task determination component 204) to create a prompt given question 122, the set of algorithms 120 and the natural language descriptions of respective algorithms in the set of algorithms 120. The prompt can also comprise questions that are semantically similar to question 122 and responses of such questions, and the prompt can be employable to determine the one or more tasks that can be executed to generate a response to question 122.

At 604, non-limiting method 600 can comprise employing LLM 112 (e.g., by task determination component 204) to create a list of algorithms that can be executed in an order or sequence to execute the one or more tasks. The sequence of execution of the algorithms can depend on the sequence of execution of the one or more tasks.

At 606, non-limiting method 600 can comprise employing LLM 112 (e.g., by task execution component 206) to select an algorithm from the list of algorithms.

At 608, non-limiting method 600 can comprise employing LLM 112 (e.g., by task execution component 206) to call/engage the algorithm given question 122.

Thereafter, non-limiting method 600 can comprise presenting (e.g., by display component 306), at 610, the execution of the algorithm to an end entity (e.g., hardware, software, machine, AI, neural network and/or user), for example, via the UI of a device, to show the thought process associated with execution of the corresponding task to the end entity. Additionally, non-limiting method 600 can comprise parsing and validating (e.g., by validation component 302), at 612, the output of the algorithm.

At 614, non-limiting method 600 can comprise determining (e.g., by validation component 302) whether question 122 has been answered.

If yes, then at 616, non-limiting method 600 can comprise paraphrasing (e.g., by rephrasing component 304 and display component 306) the output to the end entity. For example, rephrasing component 304 can transform the format of the output to a format applicable to question 122, and display component 306 can present the output, at the UI of a device, to the end entity.

If not, then at 618, non-limiting method 600 can comprise employing LLM 112 (e.g., by task execution component 206) to select a different algorithm that can be employable to execute a subsequent task, given question 122 and the output from the previously executed task.

Thereafter, at 620, non-limiting method 600 can return to 608, wherein LLM 112 can be employed (e.g., by task execution component 206) to call/engage the algorithm.

Thus, the one or more components comprised in agent 110 can interact with the set of algorithms 120 via LLM 112 to resolve a question provided by an end entity. In an exemplary application, agent 110 can extract business entities from the question, extract one or more intents associated with question 122, map the business entities to specific data sources, create a query against the data source to search for the answer, summarize the answer, and translate the answer to or from the language employed by the end entity from or two English.

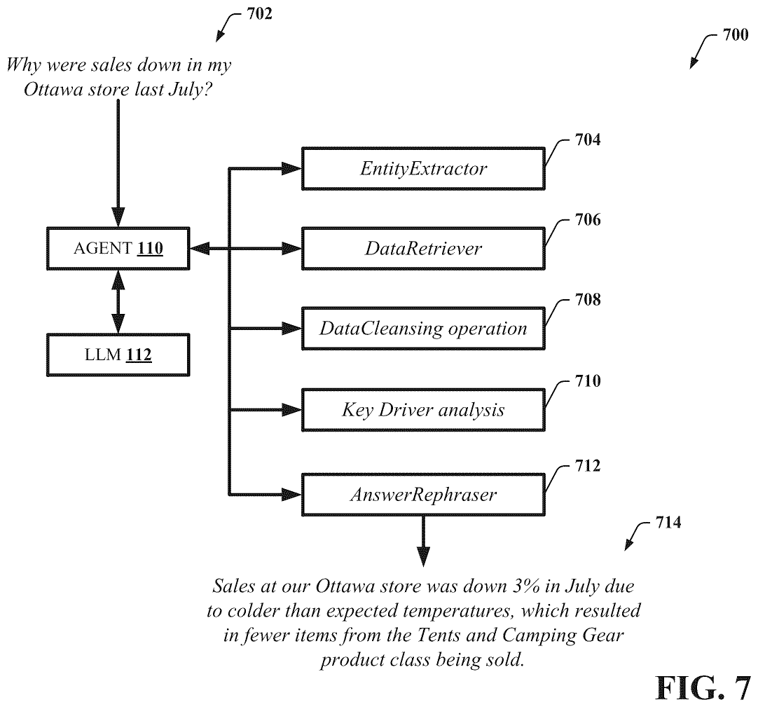

FIG. 7 illustrates a flow diagram of an example non-limiting method 700 that can employ a plurality of algorithms to process a question in accordance with one or more embodiments described herein. Repetitive description of like elements and/or processes employed in respective embodiments is omitted for sake of brevity.

Non-limiting method 700 illustrates test results based on the various embodiments described herein with reference to at least FIGS. 1-6. To generate the test results, agent 110 was employed to answer the question “Why were sales down in my Ottawa store last July?” At 702, the question was input by an end entity (e.g., hardware, software, machine, AI, neural network and/or user) into a system employing agent 110. Agent 110 accessed the question and employed LLM 112 to develop a sequence of steps or tasks based on a chain-of-thought reasoning to address the problem comprised in the question. Agent 110 further identified each algorithm to be employed to execute the sequence of tasks. An initial reasoning of agent 110 determined that to generate a response to the question, the following sequence of algorithms was to be executed:
1. Entity extractor algorithm
2. Data retriever algorithm
3. Key driver analysis algorithm
3. Answer rephraser algorithm

Agent 110 employed LLM 112 to execute the algorithms. For example, at 704, agent 110 executed the entity extractor algorithm, at 706, agent 110 executed the data retriever algorithm, and at 710, agent 110 executed the key driver analysis algorithm to produce the following analysis:

1. The entity extractor algorithm initially identified the following entities—Column: [Sales], Column Filter: [City=Ottawa], [Time=July 2023].

The output of the entity extractor algorithm was passed by agent 110 to the next task.

2. The data retriever algorithm identified the sources of data for sales, which included [Sales.csv], as well as a joinable asset that has customer feedback by store, [Survey 2023.xlsx].

The output of the data retriever algorithm was passed by agent 110 to the next task.

3. The key driver analysis algorithm was applied to the two data sources identified by the data retriever algorithm, but no anomalies or probable cause for sales were identified by the key driver analysis algorithm based on customer satisfaction of individuals that made purchases.

Agent 110 validated that no answer was reached upon execution of the key driver analysis algorithm. Thus, agent 110 backed up the process to step 2, wherein the following analysis was performed.

2. The data retriever algorithm, aware of the context of the failed step 3, identified an alternate data source with weather data that is joinable by location to Ottawa. The data retriever algorithm identified that the weather data and the store data use different foreign keys, and an additional task can be employed to resolve the question. Thus, agent 110 introduced a new task into the sequence. For example, agent 110 introduced a data cleansing algorithm based on the failure of step 2 above, to match store codes with weather data city codes. At 708, agent 110 executed the data cleansing operation.

3a. The data cleansing algorithm matched the store codes with weather data city codes.

3. The key driver analysis algorithm identified that colder temperatures caused declining sales of products offered by the store in Ottawa in the past.

The output of the key driver analysis based on the data cleansing operation was passed by agent 110 to the next task. At 712, agent 110 executed the answer rephraser algorithm.

4. The answer rephraser algorithm accepted the key driver analysis and the context of the original question as input and produced, at 714, the natural language response “Sales at our Ottawa store was down 3% in July due to colder than expected temperatures, which resulted in fewer items from the Tents and Camping Gear product class being sold.”

The final answer was returned to the end entity, including the text of the response and the reasoning of the tasks executed, wherein the reasoning further described the data sources that were used and the data cleansing task to join the two tables. Thus, agent 110 intelligently evaluated the respective outputs of respective tasks, identified a new task to be executed based on an invalid output, and successfully generated a response to the question.

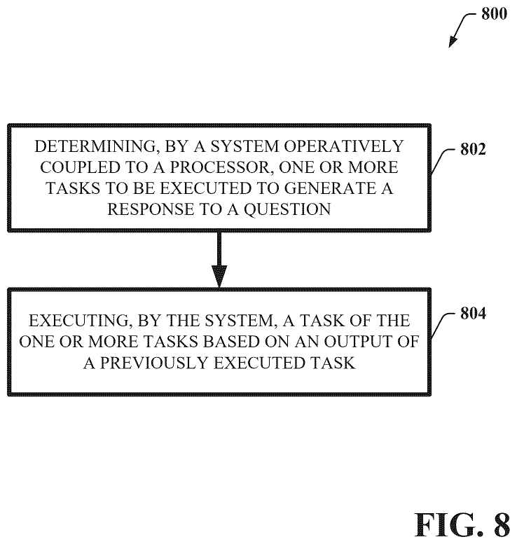

FIG. 8 illustrates a flow diagram of an example non-limiting method 800 that can determine and execute one or more tasks to generate responses to natural language questions in accordance with one or more embodiments described herein. Repetitive description of like elements and/or processes employed in respective embodiments is omitted for sake of brevity.

At 802, the non-limiting method 800 can comprise determining (e.g., by task determination component 204), by a system operatively coupled to a processor, one or more tasks to be executed to generate a response to a question.

At 804, the non-limiting method 800 can comprise executing (e.g., by task execution component 206), by the system, a task of the one or more tasks based on an output of a previously executed task.

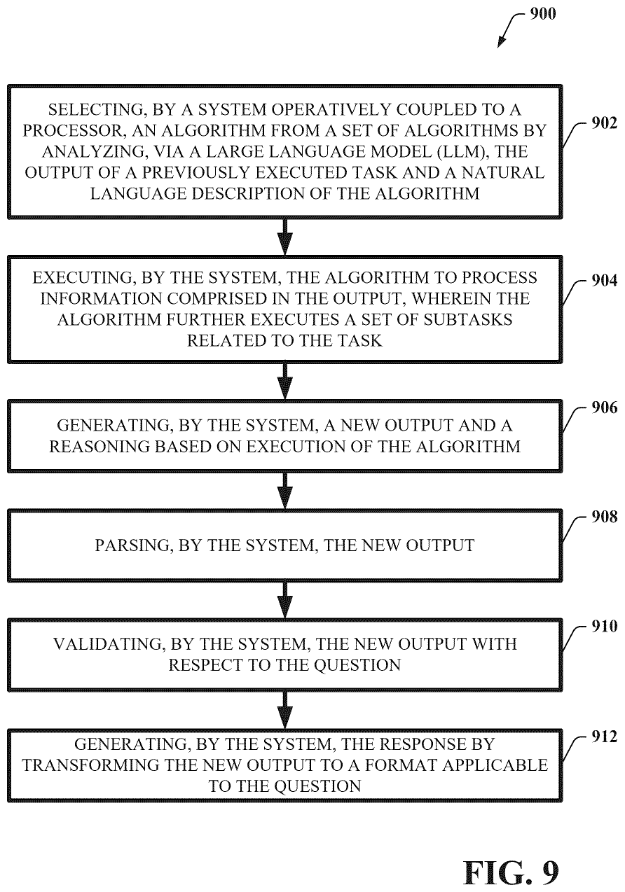

FIG. 9 illustrates another flow diagram of an example non-limiting method 900 that can determine and execute one or more tasks to generate responses to natural language questions in accordance with one or more embodiments described herein. Repetitive description of like elements and/or processes employed in respective embodiments is omitted for sake of brevity.

At 902, non-limiting method 900 can comprise selecting (e.g., by task execution component 206), by a system operatively coupled to a processor, an algorithm from a set of algorithms by analyzing, via an LLM, an output of the previously executed task and a natural language description of the algorithm.

At 904, non-limiting method 900 can comprise executing (e.g., by task execution component 206), by the system, the algorithm to process information comprised in the output, wherein the algorithm further executes a set of subtasks related to the task.

At 906, non-limiting method 900 can comprise generating (e.g., by task execution component 206), by the system, a new output and a reasoning based on execution of the algorithm.

At 908, non-limiting method 900 can comprise parsing (e.g., by validation component 302), by the system, the new output.

At 910, non-limiting method 900 can comprise validating (e.g., by validation component 302), by the system, the new output with respect to the question.

At 912, non-limiting method 900 can comprise generating (e.g., by rephrasing component 304), by the system, the response by transforming the new output to a format applicable to the question.

In summary, various embodiments of the present disclosure provide methods and techniques that can be employed to answer complex questions. The methods and techniques can comprise reviewing a question by an agent, wherein the agent can be provided one or more descriptions of and one or more examples of one or more algorithms. The agent can create or suggest a list of tasks based on the question, the one or more algorithms, and an LLM. The agent can execute a first task of the list of tasks. Further, the agent can parse and validate an output of the first task against the question. Finally, based on a determination that the output of the first task does not answer the question, the agent can employ the output of the first task and execute a second task selected from the list of tasks. The agent can validate the output of the second task and the process of executing additional tasks can conclude upon a determination by the agent that the question has been answered. In general, the methods and techniques disclosed herein can employ a composition of techniques that can generate and employ different combinations of algorithms according to different domains and use cases (e.g., BI, analytics, etc.), in a conversational manner/context.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several events and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as chain-of-thought reasoning-based response generation code 1026. In addition to block 1026, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1026, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1026 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1026 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a task determination component that determines one or more tasks to be executed to generate a response to a question; and
a task execution component that executes a task of the one or more tasks based on an output of a previously executed task.

2. The system of claim 1, wherein executing the task comprises:
selecting, by the task execution component, an algorithm from a set of algorithms by analyzing, via a large language model (LLM), the output of the previously executed task and a natural language description of the algorithm;
executing, by the task execution component, via the LLM, the algorithm to process information comprised in the output, wherein the algorithm further executes a set of subtasks related to the task; and
generating, by the task execution component, via the LLM, a new output and a reasoning based on execution of the algorithm.

3. The system of claim 2, further comprising:
a validation component that:
parses the new output; and
validates the new output with respect to the question.

4. The system of claim 3, wherein the task determination component identifies a new task to be executed upon a determination that the new output represents an incomplete response.

5. The system of claim 4, wherein the task execution component further selects a different algorithm from the set of algorithms to execute the new task.

6. The system of claim 2, further comprising:
a rephrasing component that generates the response by transforming the new output to a format applicable to the question.

7. The system of claim 1, wherein determining the one or more tasks to be executed comprises:
searching, by the task determination component, a vector database comprising embeddings of questions and responses to the questions;
retrieving, by the task determination component, from the vector database, via artificial intelligence, a set of questions that are semantically similar to the question;
generating, by the task determination component, a prompt comprising the question, contextual information associated with the question, and the set of questions; and
processing, by the task determination component, the prompt via an LLM.

8. The system of claim 1, further comprising:
a feedback component that provides a feedback mechanism employable to generate feedback on the response.

9. The system of claim 1, further comprising:
a display component that displays, at a user interface of a device, the response and a reasoning associated with each task of the one or more tasks executed to generate the response.

10. The system of claim 2, further comprising:
an access component that accesses the question, wherein the question is generated in natural language, wherein respective algorithms of the set of algorithms are associated with respective names and respective natural language descriptions, and wherein respective tasks of the one or more tasks are executable via the respective algorithms to generate the response.

11. A computer-implemented method, comprising:
determining, by a system operatively coupled to a processor, one or more tasks to be executed to generate a response to a question; and
executing, by the system, a task of the one or more tasks based on an output of a previously executed task.

12. The computer-implemented method of claim 11, further comprising:
selecting, by the system, an algorithm from a set of algorithms by analyzing, via a large language model (LLM), the output of the previously executed task and a natural language description of the algorithm;
executing, by the system, via the LLM, the algorithm to process information comprised in the output, wherein the algorithm further executes a set of subtasks related to the task; and
generating, by the system, via the LLM, a new output and a reasoning based on execution of the algorithm.

13. The computer-implemented method of claim 12, further comprising:
parsing, by the system, the new output; and
validating, by the system, the new output with respect to the question.

14. The computer-implemented method of claim 13, further comprising:
identifying, by the system, a new task to be executed upon a determination that the new output represents an incomplete response; and
selecting, by the system, a different algorithm from the set of algorithms to execute the new task.

15. The computer-implemented method of claim 12, further comprising:
generating, by the system, the response by transforming the new output to a format applicable to the question.

16. The computer-implemented method of claim 11, further comprising:
searching, by the system, a vector database comprising embeddings of questions and responses to the questions;
retrieving, by the system, from the vector database, via artificial intelligence, a set of questions that are semantically similar to the question;
generating, by the system, a prompt comprising the question, contextual information associated with the question, and the set of questions; and
processing, by the system, the prompt via an LLM.

17. The computer-implemented method of claim 11, further comprising:
displaying, by the system, at a user interface of a device, the response and a reasoning associated with each task of the one or more tasks executed to generate the response.

18. A computer program product for generating responses to natural language questions, the computer program product comprising a computer readable storage medium having program instructions embodied therewith, the program instructions executable by a processor to cause the processor to:
determine, by the processor, one or more tasks to be executed to generate a response to a question; and
execute, by the processor, a task of the one or more tasks based on an output of a previously executed task.

19. The computer program product of claim 18, wherein the program instructions are further executable by the processor to cause the processor to:
select, by the processor, an algorithm from a set of algorithms by analyzing, via a large language model (LLM), the output of the previously executed task and a natural language description of the algorithm;
execute, by the processor, the algorithm to process information comprised in the output, wherein the algorithm further executes a set of subtasks related to the task; and
generate, by the processor, a new output and a reasoning based on execution of the algorithm.

20. The computer program product of claim 19, wherein the program instructions are further executable by the processor to cause the processor to:
parse, by the processor, the new output; and
validate, by the processor, the new output with respect to the question.
